(19) United States
(12) Patent Application Publication
(10) Pub. No.: US 2022/0184978 A1
(43) Pub. Date: Jun. 16, 2022

(54) DETERMINATION OF PRINT MEDIA AMOUNT

(71) Applicant: Hewlett-Packard Development Company, L.P., Spring, TX (US)

(72) Inventors: Felicia Rezanda, Singapore (SG); Wei Lit Teoh, Singapore (SG); Seng San Koh, Singapore (SG); Fei Yuan Louisa Koh, Singapore (SG)

(73) Assignee: Hewlett-Packard Development Company, L.P., Spring, TX (US)

(21) Appl. No.: 17/598,372

(22) PCT Filed: Jul. 23, 2019
(86) PCT No.: PCT/US2019/042966

§ 371 Date: Sep. 27, 2021

(51) Int. Cl. B41J 11/42

(52) U.S. Cl. CPC B41J 11/42

(57) ABSTRACT

An example apparatus includes a processor and a memory in which is stored machine-readable instructions that are executable by the processor. The instructions cause the processor to determine a first operating torque response of a motor during a first operation of the apparatus, determine a second operating torque response of the motor during a second operation of the apparatus, the second operation being different from the first process, and determine an amount of media present in a media bin based on the first operating torque response and the second operating torque response.

### BACKGROUND

An amount of print media in a media bin of an image forming apparatus may be determined and the determined amount may be provided to a user. Based on the received information, the user may perform various operations such as reload the print media in the media bin, select to use a different image forming apparatus, etc.

### BRIEF DESCRIPTION OF DRAWINGS

Certain examples of the present disclosure will be more apparent from the following description taken in conjunction with the accompanying drawings, in which:

FIG. 1 illustrates an image forming apparatus according to an example;

FIGS. 2A-2C illustrate a torque response of a motor during a pick arm lifting operation according to an example;

FIGS. 3A-3C illustrate a torque response of a motor during a media gathering operation according to an example;

FIG. 4 illustrates an interpolated torque response of a motor during a pick arm lifting operation and a media gathering operation according to an example;

FIG. 5 illustrates an image forming apparatus having a media amount detector according to an example; and

FIG. 6 illustrates a method of determining amount of print media in a media bin of an image forming apparatus according to an example.

Throughout the drawings, it should be noted that like reference numbers are used to depict the same or similar elements, features, parts, components, and structures.

### DESCRIPTION OF EXAMPLES

In the following description, an “image forming apparatus” may refer to a device that prints print data that is generated from a terminal device, such as a computer, on a recording medium such as paper. Examples of an image forming apparatus may include a copier, a printer, a scanner, a facsimile, or a multi-function printer (MFP) that has multiple functions of the above-described devices in one unit. For sake of convenience, the terms “image forming apparatus,” “copier,” “printer,” “scanner,” “facsimile,” and “MFP” may be used interchangeably and use of one term should not be construed to limit a function of the described device, unless expressly described to the contrary.

An image forming apparatus may determine amount of media present in a media bin, such as an input tray, using a sensor, such as an opto-interrupter sensor, a reflectance sensor, or the like. The sensor may provide information of a detected stack height to a processor of the image forming apparatus. To provide accurate stack height information, an image forming apparatus may require a plurality of sensors, which may increase the cost and complexity of the image forming apparatus.

The present subject matter describes an image forming apparatus and method to determine amount of print media present in a media bin (e.g., a print media stack height) based on a torque response or a torque signature of a motor that powers a pick arm and based on a torque response or a torque signature of a motor that power a media gatherer. Here the torque response or the torque signature of the motor refers to the torque pattern of the motor as the motor controls to operate the pick arm and the media gatherer through their respective operations. By evaluating the torque response or the torque signature of the motor to determine amount of print media in a media bin, an image forming apparatus according to examples is able to reuse the pick arm and the media gatherer respectively for translating print media and gathering media so that additional components such as height detection sensors are not required. Because the determination of print media amount is made without the use of a height detection sensor, an image forming apparatus of the present subject matter is less complex and less expensive.

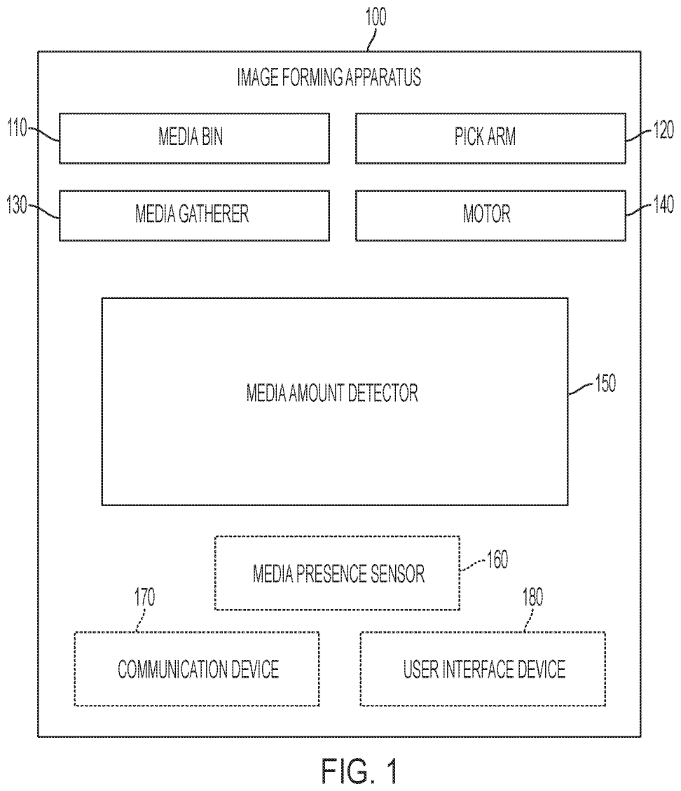

FIG. 1 illustrates an image forming apparatus according to an example.

Referring to FIG. 1, an image forming apparatus 100 may include a media bin 110, a pick arm 120, a media gatherer 130, a motor 140, and a media amount detector 150. In various examples, the image forming apparatus 100 may also include a media presence sensor 160, a communication device 170, and a user interface device 180. The image forming apparatus 100 may be an inkjet printer, an electrophotographic (EP) printer, or any other type of printer having a media bin 110, a pick arm 120, a media gatherer 130, a motor 140, and a media amount detector 150.

The media bin 110 may be an input tray, an output tray, an input bin, an output bin, or the like. In an example, the media bin 110 may be an input media tray that holds print media prior to an image forming process such as printing, copying, scanning, faxing, or a combination of these processes. The print media held by the media bin 110 may be of a certain size (e.g., letter, A3, A4, etc.), a certain stiffness as measured in gram per square meter thickness (GSM), or a certain type (plain, glossy, photo paper, card stock, etc.). The print media held by the media bin 110 may include one or more sheets. The media bin 110 may be differently arranged based on a paper path of the image forming apparatus 100. For example, the media bin may be an L-tray, in which paper may be stored in an upright orientation for supply to an L-shaped paper path, a C- or U-tray, in which paper may be stored in a flat orientation for supply to a C- or U-shaped paper path, a flat tray, in which paper may be stored in a flat orientation for supply to a flat paper path, or the like.

The pick arm 120 may translate print media in the media bin 110. As an example, the pick arm 120 may include a pick roller to draw print media from the media bin 110 into a paper path of the image forming apparatus 100. The paper path of the image forming apparatus 100 may be a pathway from the media bin 110 to a discharge unit (not shown) along which the print media may be transferred for an image forming process. The paper path may be an L-shaped path, a C- or U-shaped path, a flat path, or the like.

The pick arm 120 may move between a pick-ready position and a rest position. In the pick-ready position, the pick arm 120 contacts print media in the media bin 110 and may translate the print media in the media bin 110. For example, if the image forming apparatus 100 is performing an image forming process, the pick arm 120 may be in the pick-ready position to translate print media from the media bin 110 to the paper path. In the rest position, the pick arm 120 is located away from the print media that is in the media bin 110. The pick arm 120 may be in the rest position while the image forming apparatus 100 is in an idle state. In the rest position away from the print media in the media bin 110, the pick arm 120 will not impede loading of additional print media into the media bin 110. The pick arm 120 may move between the rest position and the pick-ready position when receiving a request to perform an image forming process, upon completion of an image forming process, when receiving a request to determine an amount of media in the media bin 110, etc.

The media gatherer 130 may operate to gather print media in the media bin 110 to provide consistency of the print media entering the paper path of the image forming apparatus 100. As an example, the media gatherer 130 may physically adjust the print media in the media bin 110 to establish or reset a desired separation angle of the print media in the media bin 110.

In an example, the media gatherer 130 may move between a retracted position, a load position, and a gathering position. In the retracted position, the media gatherer 130 is retracted from the paper path of the image forming apparatus 100 to prevent interference with the print media during an image forming process. In the load position, the media gatherer 130 is positioned to receive print media in the media bin 110 and prevent the received print media from passing from the media bin 110 into the paper path. In the gathering position, the media gatherer 130 is applied against a leading edge of the print media located in the media bin 110. By application of the media gatherer 130 in the gathering position, the media gatherer 130 provides consistency for the leading edge of each sheet or page of the print media as it leaves the media bin 110 and enters the paper path.

The motor 140 may be implemented as a single motor or a plurality of motors. The motor 140 may be a pick arm motor coupled to the pick arm 120 to drive the pick arm 120, a media gatherer motor coupled to the media gatherer 130 to drive the media gatherer 130, or a multi-purpose motor coupled to both the pick arm 120 and the media gatherer 130 to drive both the pick arm 120 and the media gatherer 130. If implemented as a multi-purpose motor, the motor 140 may also operate (e.g., drive) other components of the image forming apparatus 100, such as components along the paper path to transfer the print media during an image forming process.

The media amount detector 150 may be implemented though a combination of any suitable hardware and computer-readable instructions. The computer-readable instructions of the media amount detector 150 may be processor-executable instructions stored in a non-transitory computer-readable storage medium and the hardware for the media amount detector 150 may include a processing resource (e.g., a processor, multi-processors, etc.) to execute such instructions. In the illustrated example of FIG. 1, the non-transitory computer-readable storage medium stores instructions which, when executed by the processing resource, implement the media amount detector 150. The image forming apparatus 100 may include the non-transitory computer-readable storage medium storing the instructions and the processing resource (not shown) to execute the instructions. In an example, the non-transitory computer-readable storage medium storing the instructions may be external, but accessible to the processing resource of the image forming apparatus 100. The non-transitory computer-readable storage medium may include, for example, volatile memory (e.g., RAM), and/or non-volatile memory (e.g., EPROM, flash memory, NVRAM, memristor, etc.). In another example, the media amount detector 150 may be implemented by electronic circuitry.

The media presence sensor 160 may detect the presence of print media in the media bin 110. In an example, the media presence sensor 160 may be provided as an opto-interrupter sensor, a reflectance sensor, a pressure sensor, or the like. The media presence sensor 160 may determine that print media is present in the media bin 110 but is unable to determine an amount of print media that is present in the media bin 110.

The communication device 170 may connect the image forming apparatus 100 to an external device (not illustrated) such as a user terminal (e.g., a mobile device, a smart phone, a personal computer (PC), a tablet PC, a personal digital assistant (PDA), a digital camera), a local server, a cloud server, or the like, and transmit data, signals, images, etc. to the external device. The communication device 170 may connect the image forming apparatus 100 to the external device using a local area network (LAN) or an internet network, or using a universal serial bus port, a wireless communication port (e.g., WiFi 802.11a/b/g/n, near field communication, Bluetooth), or the like. The communication device 170 may be referred to as a communication interface, a transceiver, or the like.

The user interface device 180 may include an input unit for receiving, from a user, an input command such as for performing an image forming operation or other function of the image forming apparatus 100, and an output unit for displaying information, such as a result of performing the image forming operation or a status of the image forming apparatus 100. For example, the user interface device 180 may include an operation panel for receiving a user input and a display panel for displaying a screen. In more detail, the input unit may include at least one device for receiving various types of user inputs, such as a keyboard, a physical button, a touch screen, a camera, a microphone, or the like. Also, the output unit may include, for example, a display panel, a speaker, the touch screen, or the like. However, an example is not limited thereto, and the user interface device 180 may include a device supporting various inputs and outputs

In an example, the media amount detector 150 is coupled to the motor 140. The media amount detector 150 may control an operation of the motor 140 and may receive information from the motor 140. For example, the media amount detector 150 may output a control instruction to the motor 140 or may receive an operating parameter of the motor 140 (e.g., a voltage, a current, a speed, etc.) from the motor 140. Using the received parameters, the media amount detector 150 may determine a torque signature or torque response of the motor 140. In another example, the motor 140 may be provided with a torque sensor (not shown) and provide an output signal of the torque sensor to the media amount detector 150.

In an example, the media amount detector 150 may output a control instruction to the motor 140 to position the pick arm 120 at the pick-ready position or at the rest position. Similarly, the media amount detector 150 may output a control instruction to the motor 140 to position the media gatherer 130 at the retracted position, the load position, or the gathering position.

As an example, the media amount detector 150 may provide a control instruction to the motor 140 to move the pick arm 120 from the rest position, to the pick-ready position, and back to the rest position. In response, the motor 140 may operate to move the pick arm 120 as instructed by the media amount detector 150 and may provide operating parameters such as voltage, current, speed, etc. of the motor 140 during the operation to the media amount detector 150. Using the provided operating parameters, the media amount detector 150 may determine a first torque response of the motor 140 during the process of moving the pick arm 120 from the pick-ready position to the rest position. A movement of the pick arm from the pick-ready position to the rest position may be termed a pick arm lifting operation.

In an example, the media amount detector 150 may provide a control instruction to the motor 140 to move the media gatherer 130 from the load position to the gathering position. In response, the motor 140 may operate to move the media gatherer 130 as instructed by the media amount detector 150 and provide operating parameters such as voltage, current, speed, etc. of the motor 140 during the operation to the media amount detector 150. Using the provided operation parameters, the media amount detector 150 may determine a second torque response of the motor 140 during the process of moving the media gatherer 130 from the load position to the gathering position. A movement of the media gatherer from the load position to the gathering position may be termed a media gathering operation.

The media amount detector 150 may evaluate and interpolate data from the determined first torque response of the motor 140 and the determined second torque response of the motor 140. In an example, the media amount detector 150 may compare the evaluated and interpolated data with torque response data stored in the non-transitory computer readable medium (e.g., the volatile memory or non-volatile memory) of the image forming apparatus 100. The non-transitory computer readable medium may include a look-up table including torque response data during operation of the pick arm 120 and torque response data during operation of the media gatherer 130. By comparing the evaluated and interpolated data with the torque response data in the look-up table, the media amount detector 150 may determine amount of print media in the media bin 110.

In an example, the media amount detector 150 may evaluate and interpolate data from the determined first torque response of the motor 140 and the determined second torque response of the motor 140 with sufficient accuracy to establish at least three levels of print media in the media bin 110, such as a low level, a medium level, and a high level. In an example, the data from the determined first torque response of the motor 140 and the determined second torque response of the motor 140 may be evaluated and interpolated to determine at least five levels of print media in the media bin 110, such as a low level, a medium-low level, a medium level, a medium-high level, and a high level.

In another example, the media amount detector 150 may provide the determined first torque response of the motor 140 and the determined second torque response of the motor 140 to an external device, such as an external server, using the communication device 170. In response, the media amount detector 150 may receive information of amount of print media in the media bin 110 from the external device using the communication device 170.

Operation of the pick arm 120 from the pick-ready position to the rest position by the motor 140 may result in a first torque response of the motor 140 that is distinct when amount of print media in the media bin 110 is low. Similarly, operation of the media gatherer 130 from the load position to the media gathering position by the motor 140 may result in a second torque response of the motor 140 that is distinct when amount of print media in the media bin 110 is high. By evaluating and interpolating the first torque response and the second torque response of the motor 140 during the operations of pick arm lifting and media gathering respectively, amount of print media in the media bin 110 may be determined with sufficient accuracy to assess a multi-level status of the print media (e.g., low-medium-high, etc.).

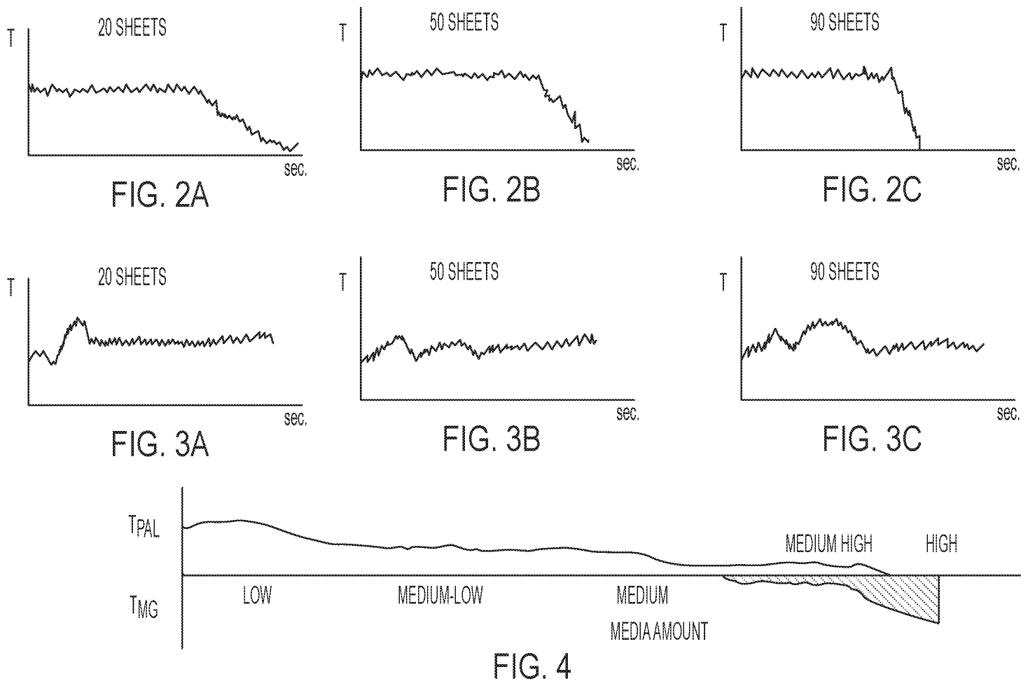

FIGS. 2A-2C illustrate a torque response of a motor during a pick arm lifting operation according to an example. FIGS. 3A-3C illustrate a torque response of a motor during a media gathering operation according to an example. FIG. 4 illustrates an interpolated torque response of a motor during a pick arm lifting operation and a media gathering operation according to an example.

Referring to FIGS. 2A-2C, a torque response of a motor during a pick arm lifting operation is illustrated for different amounts of print media present in a media bin. In more detail, FIGS. 2A-2C are graphs of a motor torque response generated during a pick arm lifting operation when there are 20 sheets, 50 sheets, and 90 sheets of print media present in a media bin, respectively. In the illustrated example, the torque response varies depending on amount of print media in the media bin. In more detail, a magnitude of a downward slope of the torque response and a time point during the pick arm operation when the downward slope begins vary depending on amount of print media in the media bin.

Referring to FIGS. 3A-3C, a torque response of a motor during a media gathering operation is illustrated for different amounts of print media present in a media bin. In more detail, FIGS. 3A-3C are graphs of a motor torque response generated during a media gathering operation when there are 20 sheets, 50 sheets, and 90 sheets of print media present in a media bin, respectively. In the illustrated example, the torque response varies depending on amount of print media in the media bin. In more detail, a magnitude of an upward slope of the torque response, a positive peak of the torque response, a duration of applied torque prior to a downward slope of the torque response, a negative peak of the torque response, and other parameters of the torque response vary depending on amount of print media in the media bin.

Referring to FIG. 4, an interpolated result of the torque response of the motor during the pick arm operation illustrated in FIGS. 2A-2C and of the torque response of the motor during the media gathering operation illustrated in FIGS. 3A-3C is provided. In the example of FIG. 4, a top curve corresponds to a motor torque during a pick arm lifting operation (T_{PAL}) while a bottom curve corresponds to a motor torque during a media gathering operation (T_{MG}). In the example of FIGS. 2A-2C, 3A-3C, and 4, the motor torque response is sufficiently distinct during the pick arm lifting operation and the media gathering operation such that, upon interpolation of the torque responses, the graph of the interpolated results allows for determining print media amounts of low, medium-low, medium, medium-high, and high.

In an example, the results of obtaining of the torque response of the motor during the pick arm lifting operation, obtaining of the torque response of the motor during the media gathering operation, and interpolation of the torque responses may be stored in a media amount detector provided with an image forming apparatus. By storing the resultant information in the media amount detector of the image forming apparatus, the image forming apparatus having the media amount detector may cause a motor to subsequently perform a pick arm lifting operation and a media gathering operation, determine a torque response for each operation, interpolate the resultant torque responses, and determine an amount of print media by comparing the interpolated result with the stored result.

While FIGS. 2A-2C, 3A-3C, and 4 have been provided as illustrations of a torque response of a motor during a pick arm lifting operation for various print media amounts, a torque response of a motor during a media gathering operation for various print media amounts, and an interpolation of those torque responses, it is to be understood that these graphs and interpolated results are merely examples. In other examples, the torque response of the motor during either or both of a pick arm lifting operation and a media gathering operation may be different from that illustrated in FIGS. 2A-2C, 3A-3C, and 4. For example, a first torque response of a motor during a pick arm lifting operation and a second torque response of a motor during a media gathering operation vary depending on aspects of an image forming apparatus in which the operations are performed. Thus, while one image forming apparatus may include a motor, a pick arm, a media gatherer, a media bin, etc. that results in data such as that illustrated in FIGS. 2A-2C, 3A-3C, and 4, in other examples, an image forming apparatus may be differently configured. Thus, while a torque response of a motor during a pick arm lifting operation and a media gathering operation and an interpolation of those torque responses may be sufficiently distinct to allow for determining an amount of print media in a media bin, the data may vary from that illustrated in FIGS. 2A-2C, 3A-3C, and 4.

Furthermore, while the examples of FIGS. 2A-2C, 3A-3C, and 4 illustrate torque responses for 20 pages, 50 pages, and 90 pages, it is to be understood that these values are simply an example and not to be construed as limiting. Rather, the torque responses may be determined for any amount of media in a media bin.

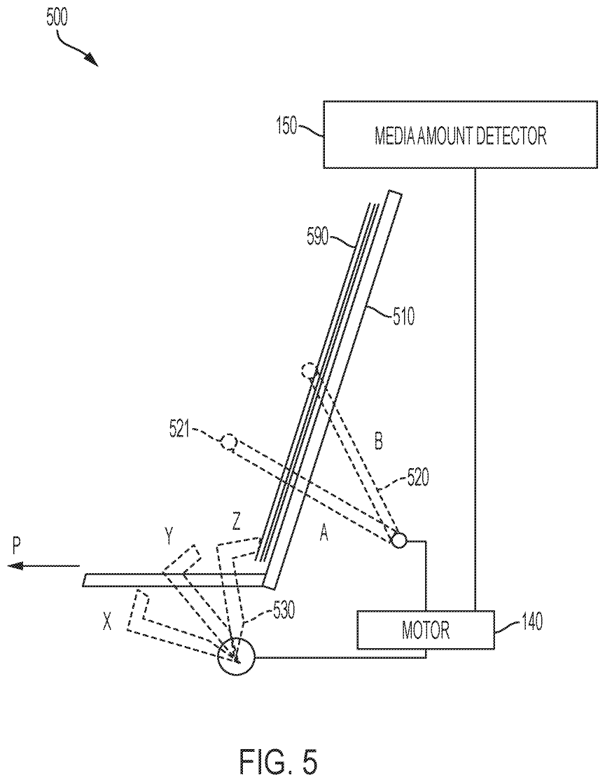

FIG. 5 illustrates an image forming apparatus having a media amount detector according to an example.

Referring to FIG. 5, an image forming apparatus 500 may include a media bin 510, similar to the media bin 110 of the image forming apparatus 100, a pick arm 520, similar to the pick arm 120 of the image forming apparatus 100, a media gatherer 530, similar to the media gatherer 130 of the image forming apparatus 100, the motor 140, and the media amount detector 150. Although not illustrated, the image forming apparatus 500 may also include the media presence sensor 160, the communication device 170, and the user interface device 180. The pick arm 520 may also include a pick roller 521 and the image forming apparatus 500 may also include print media 590 loaded or stacked on the media bin 510.

In an example, the motor 140 may be coupled to the pick arm 520 and the motor 140 may be coupled to the media gatherer 530. The motor 140 may also be coupled to the media amount detector 150. By operation of the motor 140, the pick arm 520 may be moved between a rest position A and a pick-ready position B. In an example, the pick arm 520 may be located in the rest position A when the image forming apparatus 500 is in an idle mode or otherwise not performing an image forming process. In the rest position A, the pick arm 520 is not in contact with print media 590.

By operation of the motor 140, the pick arm 520 may move to the pick-ready position B. In the pick-ready position B, the pick roller 521 is in contact with the print media 590. In the pick-ready position B, the pick roller 521 may be rotated by operation of the motor 140 to translate a sheet or page of the print media 590 in a direction P towards a print path of the image forming apparatus 500.

By operation of the motor 140, the pick arm 520 may move from the pick-ready position B to the rest position A. A movement of the pick arm 520 from the pick-ready position B to the rest position A may be termed a pick arm lifting operation. Movement of the pick arm 520 from the pick-ready position B to the rest position A may occur upon completion of an image forming process, as a pre-scheduled operation of the image forming apparatus 500, upon a request by a user, upon receipt of a command from an external device, upon receipt of a media presence signal from the media presence sensor 160, etc. A torque response or torque signature of the motor 140 when moving the pick arm 520 from the pick-ready position B to the rest position A may be considered a first torque response.

By operation of the motor 140, the media gatherer 530 may be moved between a retracted position X, a load position Y, and a gathering position Z. In an example, the media gatherer 530 may be located in the load position Y when the image forming apparatus 500 is in an idle mode or otherwise not performing an image forming process. In the load position Y, the media gatherer 530 may assist in receiving the print media 590 in the media bin 510 by preventing the loaded print media 590 from continuing towards the paper path P. During an image forming process of the image forming apparatus 500, the media gatherer 530 may be moved by the motor 140 between the retracted position X and the gathering position Z. As an example, the motor 140 may control the media gatherer 530 to move between the retracted position X and the gathering position Z after each selection of a page or sheet of the print media 590 by the pick roller 521 from the media bin 510. By movement of the media gatherer 530 between the retracted position X and the gathering position Z, a leading edge of the remaining pages or sheets of the print media 590 will be properly positioned for movement to the paper path P when translated by the pick roller 521, and the media gatherer 530 will then be retracted to avoid obstructing the paper path.

In an example, the motor 140 may operate to move the media gatherer 530 to the load position Y and operate to move the media gatherer 530 from the load position Y to the gathering position Z. A movement of the media gatherer 530 from the load position Y to the gathering position Z may be termed a media gathering operation. Movement of the media gatherer 530 from the load position Y to the gathering position Z may occur as a pre-scheduled operation of the image forming apparatus 500, upon request by a user, upon receipt of a command from an external device, upon receipt of a media presence signal from the media presence sensor 160, etc. A torque response or torque signature of the motor 140 when moving the media gatherer 530 from the load position Y to the gathering position Z may be considered a second torque response.

As an example, the media amount detector 150 may receive an input to determine amount of the print media 590 in the media bin 510. As an example, the media amount detector 150 may receive an input that print media presence in the media bin 510 has been detected by the media presence sensor 160. An input from the media presence sensor 160 may indicate that a user or operator has refilled the media bin 510 with the print media 590. In other examples, a selection to determine amount of the print media 590 in the media bin 510 may be received from a user using the user interface device 180, from an external user device by the communication device 170, from a remote source by the communication device 170, based on a predetermined number of image forming processes performed by the image forming apparatus 500, etc.

Based on the received input to determine amount of print media in the media bin 510, the media amount detector 150 may control the motor 140 to position the pick arm 520 in the pick-ready position B and move the pick arm 520 from the pick-ready position B to the rest position A. That is, the motor 140 may control the pick arm 520 to perform a pick arm lifting operation. During movement of the pick arm 520 from the position B to the position A, the motor 140 may provide various operating parameters such as voltage, current, speed, etc. to the media amount detector 150. Using the received operating parameters of the motor 140, the media amount detector 150 may determine a torque response of the motor 140 during the pick arm lifting operation to be a first torque response.

Also based on the received input to determine amount of print media in the media bin 510, the media amount detector 150 may control the motor 140 to position the media gatherer 530 in the load position Y and move the media gatherer 530 from the load position Y to the gathering position Z. During movement of the media gatherer 530 from the load position Y to the gathering position Z, the motor 140 may provide various operating parameters such as voltage, current, speed, etc. to the media amount detector 150. Using the received operating parameters of the motor 140, the media amount detector 150 may determine a torque response of the motor 140 during the movement of the media gatherer 530 to be a second torque response. Although it has been described that the media amount detector 150 controls movement of the pick arm 520 before controlling movement of the media gatherer 530, this is only for example and the operations may be performed in any order.

In an example, the media amount detector 150 evaluates and interpolates data of the first torque response and the second torque response to determine amount of print media in the media bin 510. For example, the media amount detector 150 may compare the evaluated and interpolated data with values stored in a look-up table of the media amount detector 150. By comparing the evaluated and interpolated data with the stored values, the media amount detector 150 may determine amount of print media 590 in the media bin 510. The determined amount of print media 590 in the media bin 510 may be one of low, medium, or high, or may be one of low, low-medium, medium, high-medium, or high.

The media amount detector 150 may provide the determined amount of print media 590 to the communication device 170 for transmission to an external device, such as a user's portable device or a remote server, or may provide the determined amount of print media 590 to the user interface device 180 for display at the image forming apparatus 500. In any case, a user or operator may determine to use the image forming apparatus 500, refill the print media 590 if it is determined to be below a desired level, determine to use another image forming apparatus, etc. based on the received information of print media amount.

In an example, the image forming apparatus 500 may receive updated information concerning a first or a second motor torque response or updated information of an interpolation of motor torque responses. For example, the communication device 170 may receive updated information from an external source of the image forming apparatus 500, such as a manufacturer of the image forming apparatus 500. The received updated information may be stored by the media amount detector 150 for use in determining amount of media in the media bin 590.

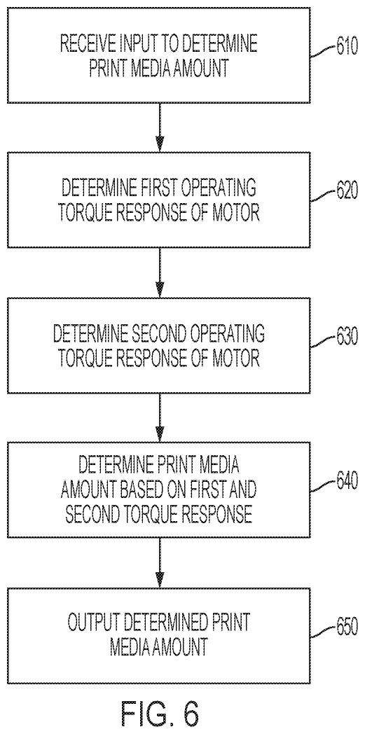

FIG. 6 illustrates a method of determining amount of print media in a media bin of an image forming apparatus according to an example.

Referring to FIG. 6, an image forming apparatus may receive an input to determine amount of print media in operation 610. In various examples, the input may be received from a user or an operator of the image forming apparatus, may be received from a user or an operator of an external apparatus such as a user's portable device or a remote server in communication with the image forming apparatus, may be received based on an indication of media presence from a media presence sensor, may be received based on a number of image forming processes completed by the image forming apparatus, or the like.

In operation 620, the image forming apparatus may determine a first operating torque response of a motor. As an example, based on receipt of the input to determine amount of print media, the image forming apparatus may control a motor to perform a pick arm lifting operation. Based on receipt of motor parameters during the pick arm lifting operation, the image forming apparatus may determine a first operating torque response of the motor.

In operation 630, the image forming apparatus may determine a second operating torque response of a motor. As an example, based on receipt of the input to determine amount of print media, the image forming apparatus may control a motor to perform a media gathering operation. Based on receipt of motor parameters during the media gathering operation, the image forming apparatus may determine a second operating torque response of the motor.

In operation 640, the image forming apparatus may determine amount of print media based on the determined first operating torque response of the motor and the determined second operating torque response of the motor. As an example, the image forming apparatus may analyze and interpolate data of the first and second torque responses and compare the analyzed and interpolated data with data previously stored in the image forming apparatus. Based on the comparison, amount of print media may be determined as one of low, medium, or high, or as one of low, medium-low, medium, medium-high, or high.

In operation 650, the determined print media amount may be output by the image forming apparatus. For example, the determined print media amount may be output to a display device, such as a user interface, of the image forming apparatus. In another example, the determined print media amount may be output to an external device such as a user's portable device, a user's workstation, a remote server, or the like.

As described above, a media amount detector may control a motor to operate a pick arm and a media gatherer to determine a first torque response and a second torque response, respectively. The first torque response and the second torque response may be used to determine amount of the print media in the media bin, which allows for elimination of print media height detection sensors.

While the present disclosure has been shown and described with reference to various examples thereof, it will be understood by those skilled in the art that various changes in form and details may be made therein without departing from the spirit and scope of the present disclosure as defined by the appended claims and their equivalents. Therefore, the scope of the present disclosure should be defined not by the described examples alone, but by the appended claims and the equivalents thereof.

In the above description, when an element is referred to as being “connected” or “coupled” to another element, it can be directly connected or coupled to the other element or it can be connected or coupled to the other element with intervening elements interposed therebetween.

In the above description, a singular expression includes a plural expression, unless otherwise specified. It is also to be understood that terms such as “comprises” or “includes” are used herein to designate the presence of a characteristic, a number, a step, an operation, an element, a component, or a combination thereof, and not to preclude the presence or the possibility of adding one or more of other characteristics, numbers, steps, operations, elements, components, or a combination thereof. It is also to be understood that terms such as “first,” “second,” or the like are used to differentiate between objects having the same or similar terminology and are in no way intended to represent an order, unless where explicitly stated otherwise.

What is claimed is:

1. An apparatus comprising:
a processor; and
a memory in which is stored machine-readable instructions that are executable by the processor to:
determine a first operating torque response of a motor during a first operation of the apparatus,
determine a second operating torque response of the motor during a second operation of the apparatus, the second operation being different from the first operation, and
determine an amount of media present in a media bin based on the first operating torque response and the second operating torque response.

2. The apparatus of claim 1, wherein the media bin comprises an L-tray, a C-tray, or a flat tray.

3. The apparatus of claim 1, wherein the first operation of the apparatus comprises:
positioning a pick arm at a pick-ready position in contact with the media present in the media bin; and
moving the pick arm to a rest position away from the media present in the media bin.

4. The apparatus of claim 1, wherein the second operation of the apparatus comprises a media gathering operation.

5. The apparatus of claim 4, wherein the media gathering operation comprises resetting a separation angle of the media present in the media bin.

6. The apparatus of claim 1, wherein the instructions are further to cause the processor to determine the amount of media present in the media bin as one of at least three different amounts of media.

7. The apparatus of claim 1, further comprising:
a communication device; and
a user interface device,
wherein the instructions are further to cause the processor to provide an indication of the amount of media present in the media bin to one of the communication device or the user interface device.

8. The apparatus of claim 1, wherein the instructions are further to cause the processor to determine the amount of media present in the media bin based on interpolating between the first operating torque response and the second operating torque response and comparing the interpolation result to torque response data included in the memory.

9. The apparatus of claim 1, wherein the instructions are further to cause the processor to:
receive an input of a sensor indicating that media is present in the media bin, and
determine the first operating torque response of the motor during the first operation of the apparatus and the second operating torque response of the motor during the second operation of the apparatus based on the receipt of the sensor input indicating that the media is present in the media bin.

10. A printing apparatus comprising:
a media bin;
a pick arm;
a media gatherer;
at least one motor;
a processor; and
a memory in which is stored machine-readable instructions that are executable by the processor to:
receive an input to determine an amount of print media present in the media bin,
determine a first operating torque response of the at least one motor during a pick arm operation,
determine a second operating torque response of the at least one motor during a media gatherer operation, and
determine the amount of the print media present in the media bin by interpolating the first operating torque response and the second operating torque response and comparing the interpolation result to torque response data included in the memory.

11. The printing apparatus of claim 10, wherein the pick arm operation comprises:
positioning the pick arm at a pick-ready position in contact with the print media present in the media bin; and
moving the pick arm to a rest position away from the print media present in the media bin.

12. The printing apparatus of claim 10, further comprising a media presence sensor, wherein the instructions to receive the input to determine the amount of print media present in the media bin include instructions to receive an indication from the media presence sensor that the print media is present in the media bin.

13. The printing apparatus of claim 10, further comprising a communication device to transmit an indication of the determined amount of print media present in the media bin to an external device.

14. A non-transitory machine-readable storage medium encoded with instructions executable by a processor, the non-transitory machine-readable storage medium comprising:
instructions to determine a first operating torque response of a motor during a pick arm lifting operation;
instructions to determine a second operating torque response of the motor during a media gathering operation;
instructions to interpolate between the determined first operating torque response and the second operating torque response; and
instructions to determine an amount of print media present in a media bin based on the interpolation.

15. The non-transitory machine-readable storage medium of claim 14, further comprising:
instructions to receive an input of a media presence sensor indicating that print media is present in the media bin; and
instructions to determine the first operating torque response of the motor during the pick arm lifting operation and the second operating torque response of the motor during the media gatherer operation based on the receipt of the media presence sensor input indicating that the print media is present in the media bin.
